(19) United States
(12) Patent Application Publication
(10) Pub. No.: US 2026/0015191 A1
(43) Pub. Date: Jan. 15, 2026

(54) MEDIUM CONVEYING APPARATUS

(71) Applicant: PFU LIMITED, Kahoku-shi (JP)

(72) Inventors: Hisashi Ogi, Kahoku-shi (JP); Takumi Ito, Kahoku-shi (JP)

(21) Appl. No.: 19/257,992

(22) Filed: Jul. 2, 2025

(30) Foreign Application Priority Data
Jul. 12, 2024 (JP) 2024-112530

(51) Int. Cl. B65H 3/06; B65H 7/00; H04N 1/00

(52) U.S. Cl. CPC B65H 3/0669; B65H 3/0661; B65H 3/0676; B65H 7/00; B65H 2301/4232; B65H 2403/72; B65H 2557/30; B65H 2801/39; H04N 1/00602; H04N 1/00628

(57) ABSTRACT

A medium conveying apparatus includes a driving source to generate a driving force, a separation roller to separate a medium with the driving force, a mechanical clutch, and an applying part. The mechanical clutch includes a driving wheel rotated by the driving force from the driving source, and a driven wheel coupled to and uncoupled from the driving wheel by rotation of the driving wheel. The driven wheel coupled to the driving wheel transmits the driving force from the driving wheel to the separation roller. The applying part applies, to the driven wheel, a frictional force for restricting rotation of the driven wheel rotated by the driving wheel, and the frictional force applied by the applying part is greater than a frictional force between the driving wheel and the driven wheel.

### CROSS-REFERENCE TO RELATED APPLICATIONS

This patent application is based on and claims priority pursuant to 35 U.S.C. § 119(a) to Japanese Patent Application No. 2024-112530, filed on Jul. 12, 2024, in the Japan Patent Office, the entire disclosure of which is hereby incorporated by reference herein.

### BACKGROUND

The present disclosure relates to a medium conveying apparatus.

Typically, a medium conveying apparatus, such as a scanner or a printer, includes a separation roller to separate a medium, and has a separation mode in which media are conveyed while being separated and a non-separation mode in which a medium is conveyed without being separated.

In a sheet feeding apparatus, the operation mode of a feeder can be switched between a separation mode, in which sheets are separated one by one from a sheet stacker and fed, and a non-separation mode, in which sheets are fed without being separated. In this sheet feeding apparatus, a drive transmission mechanism to transmit a driving force from a driving source to a retard roller includes a clutch such as an electromagnetic clutch. The clutch is coupled to the retard roller to turn on and off the driving of the retard roller.

### SUMMARY

The medium conveying apparatus according to one aspect of the present disclosure includes a driving source to generate a driving force, a separation roller to separate a medium with the driving force, a mechanical clutch, and an applying part. The mechanical clutch includes a driving wheel rotated by the driving force from the driving source, and a driven wheel coupled to and uncoupled from the driving wheel by rotation of the driving wheel. The driven wheel coupled to the driving wheel transmits the driving force from the driving wheel to the separation roller. The applying part applies, to the driven wheel, a frictional force for restricting rotation of the driven wheel rotated by the driving wheel, and the frictional force applied by the applying part is greater than a frictional force between the driving wheel and the driven wheel.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium conveying apparatus according to an embodiment;

FIG. 2 is a diagram illustrating a conveying path inside the medium conveying apparatus illustrated in FIG. 1;

FIG. 3 is a schematic perspective view of a driving mechanism of the medium conveying apparatus illustrated in FIG. 1;

FIGS. 4A-1 to 4D-2 are schematic diagrams for explaining the operation of a clutch of the driving mechanism illustrated in FIG. 3;

FIGS. 5A-1 to 5D-2 are schematic diagrams for explaining the operation of the clutch of the driving mechanism illustrated in FIG. 3;

FIG. 6 is a schematic perspective view of the clutch illustrated in FIGS. 4A-1 to 5A-2 for explaining an applying part and a pressing part thereof;

FIG. 7 is a block diagram illustrating a schematic configuration of the medium conveying apparatus illustrated in FIG. 1;

FIG. 8 is a block diagram illustrating a schematic configuration of a memory and a processing circuit illustrated in FIG. 7;

FIG. 9 is a flowchart of a medium conveying process performed by the medium conveying apparatus illustrated in FIG. 1;

FIG. 10 is a schematic view of another applying part; and

FIG. 11 is a diagram illustrating a schematic configuration of another processing circuit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A medium conveying apparatus according to embodiments of the present disclosure will be described below with reference to the drawings. The technical scope of the present disclosure is not limited to the embodiments described below and covers equivalents of elements described below.

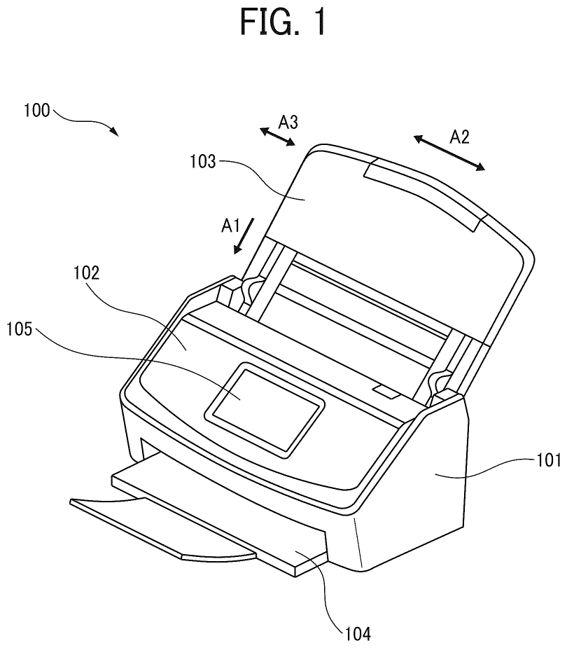

FIG. 1 is a perspective view of a medium conveying apparatus 100 that is an image scanner.

The medium conveying apparatus 100 conveys, images, and ejects media that are documents. Examples of the media include paper, thick paper, cards, booklets, and passports. The medium conveying apparatus 100 may be a facsimile machine, a copier, or a multifunction peripheral (MFP). An MFP may also be called a multifunction printer.

In FIG. 1, arrow A1 indicates the direction in which a medium is conveyed (also “medium conveying direction A1”), arrow A2 indicates the width direction perpendicular to the medium conveying direction A1, and arrow A3 indicates the height direction perpendicular to a medium conveying path. In the following, upstream is upstream in the medium conveying direction A1, and downstream is downstream in the medium conveying direction A1. The width direction A2 is an example of a direction intersecting the medium conveying direction A1.

The medium conveying apparatus 100 includes a lower housing 101, an upper housing 102, a media tray 103, an ejection tray 104, and a display and operation device 105.

The upper housing 102 is located to cover the upper side of the medium conveying apparatus 100 and is hinged to the lower housing 101 such that the upper housing 102 is opened and closed to, for example, remove a jammed medium or clean the inside of the medium conveying apparatus 100.

The media tray 103 is hinged to the lower housing 101 and is rotatable. When the medium conveying apparatus 100 is not used, the media tray 103 is located to cover the lower housing 101 and the upper housing 102 and functions as an exterior cover. When the medium conveying apparatus 100 is used, the media tray 103 is located at such a position that media to be fed and conveyed can be placed thereon. The ejection tray 104 is engaged with the lower housing 101, and the ejected media are stacked thereon. The ejection tray 104 may be engaged with the upper housing 102 with a hinge or the like.

The display and operation device 105 includes a display and an interface circuit that outputs image data to the display, and displays the image data on the display. Examples of the display include a liquid crystal display and an organic electro-luminescence (EL) display. The display and operation device 105 further includes a touch-screen input device and an interface circuit that receives signals from the input device. The display and operation device 105 receives an input operation performed by a user and outputs an operation signal corresponding to the input operation performed by the user. The medium conveying apparatus 100 may include a display device and an operation device separately.

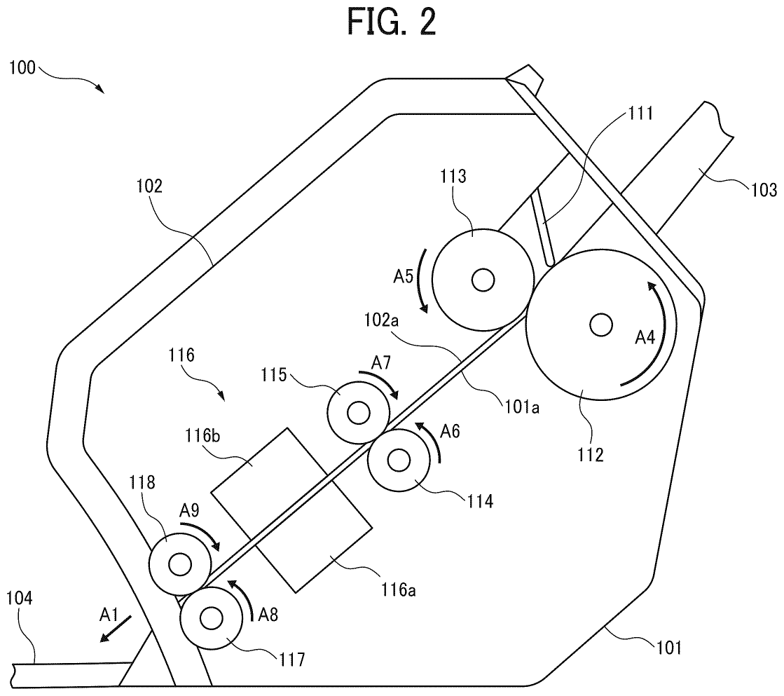

FIG. 2 is a diagram illustrating a medium conveying path inside the medium conveying apparatus 100.

The medium conveying apparatus 100 includes a media sensor 111, a feed roller 112, a separation roller 113, a first conveyance roller 114, a second conveyance roller 115, an imaging device 116 including an image sensor, a first ejection roller 117, and a second ejection roller 118 along the medium conveying path.

The number of each of the feed roller 112, the separation roller 113, the first conveyance roller 114, the second conveyance roller 115, the first ejection roller 117, and/or the second ejection roller 118 is not limited to one but may be two or more. When the feed roller 112, the separation roller 113, the first conveyance roller 114, the second conveyance roller 115, the first ejection roller 117, and/or the second ejection roller 118 are formed of multiple rollers, the multiple rollers are located at intervals in the width direction A2. The first conveyance roller 114, the second conveyance roller 115, the first ejection roller 117, and/or the second ejection roller 118 are examples of conveyance rollers to convey media.

The upper face of the lower housing 101 forms a lower guide 101a for the medium conveying path, and the lower face of the upper housing 102 forms an upper guide 102a for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104. Since the medium conveying path is a straight path, the medium conveying apparatus 100 is compact.

The media sensor 111 is located upstream from the feed roller 112 and the separation roller 113. The media sensor 111 includes a contact sensor and detects whether a medium is placed on the media tray 103. The media sensor 111 generates a media signal having a value that changes depending on whether a medium is placed on the media tray 103 and outputs the generated media signal. The media sensor 111 is not limited to a contact sensor but may be any sensor, such as an optical sensor to detect the presence of a medium.

The feed roller 112 is in the lower housing 101, separates the media on the media tray 103 one by one from the bottom, and sequentially feeds the media. The separation roller 113 is a so-called brake roller or retard roller, located in the upper housing 102, and faces the feed roller 112. The separation roller 113 separates a medium from the media on the media tray 103. The separation roller 113 is rotatable in the direction indicated by arrow A5 opposite to the rotation direction for conveying the media (may be referred to as a medium feeding direction in the following description). Alternatively, the separation roller 113 can be kept stationary. Instead of the separation roller 113, a separation pad may be used.

The first conveyance roller 114 and the second conveyance roller 115 are located downstream from the feed roller 112 and the separation roller 113 in the medium conveying direction A1 and face each other. The first conveyance roller 114 and the second conveyance roller 115 convey the medium fed by the feed roller 112 and the separation roller 113 to the imaging device 116.

The imaging device 116 images the medium conveyed by the first conveyance roller 114. The imaging device 116 includes a first imaging device 116a and a second imaging device 116b facing each other across the medium conveying path.

The first imaging device 116a includes an imaging sensor that is a unity-magnification contact image sensor (CIS). The CIS includes complementary metal oxide semiconductor (CMOS) imaging elements aligned linearly in the main scanning direction. The first imaging device 116a further includes a lens that forms an image on the imaging elements and an analog-to-digital (A/D) converter. The A/D converter amplifies the electrical signals output from the imaging elements and performs analog-to-digital (A/D) conversion. The first imaging device 116a images the front side of the medium being conveyed, generates input images sequentially, and outputs the input images.

Similarly, the second imaging device 116b includes an imaging sensor that is a unity-magnification CIS including CMOS imaging elements aligned linearly in the main scanning direction. The second imaging device 116b further includes a lens that forms an image on the imaging elements and an A/D converter. The A/D converter amplifies the electrical signals output from the imaging elements and performs A/D conversion. The second imaging device 116b images the back side of the medium being conveyed, generates input images sequentially, and outputs the input images.

The medium conveying apparatus 100 may include only one of the first imaging device 116a and the second imaging device 116b to read only one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The first ejection roller 117 and the second ejection roller 118 are located downstream from the imaging device 116 in the medium conveying direction A1 and face each other. The first ejection roller 117 and the second ejection roller 118 eject the medium that is conveyed by the first conveyance roller 114 and the second conveyance roller 115 and is processed (imaged) by the imaging device 116 to the ejection tray 104.

The media placed on the media tray 103 are conveyed between the lower guide 101a and the upper guide 102a in the medium conveying direction A1 as the feed roller 112 rotates in the direction indicated by arrow A4 in FIG. 2, which is the medium feeding direction. The medium conveying apparatus 100 has two operation modes: a separation mode, in which one medium is separated and fed from the media on the media tray 103, and a non-separation mode, in which media are fed without being separated. In the separation mode, the separation roller 113 rotates in the direction indicated by arrow A5 opposite to the medium feeding direction or is kept stationary when a medium is conveyed. When two or more media are placed on the media tray 103, only the medium in contact with the feed roller 112 is separated from the rest of the media on the media tray 103 due to the action of the feed roller 112 and the separation roller 113. This operation prevents the feeding of a medium other than the separated medium (prevention of multi-feed). In the non-separation mode, the separation roller 113 is rotated by the feed roller 112 in the medium feeding direction opposite to the direction indicated by arrow A5 when conveying a medium.

The medium is fed between the first conveyance roller 114 and the second conveyance roller 115 while being guided by the lower guide 101a and the upper guide 102a. The medium is fed between the first imaging device 116a and the second imaging device 116b as the first conveyance roller 114 and the second conveyance roller 115 rotate in the directions indicated by arrows A6 and A7 in FIG. 2, respectively. The medium read by the imaging device 116 is ejected onto the ejection tray 104 as the first ejection roller 117 and the second ejection roller 118 rotate in the directions indicated by arrows A8 and A9 in FIG. 2, respectively.

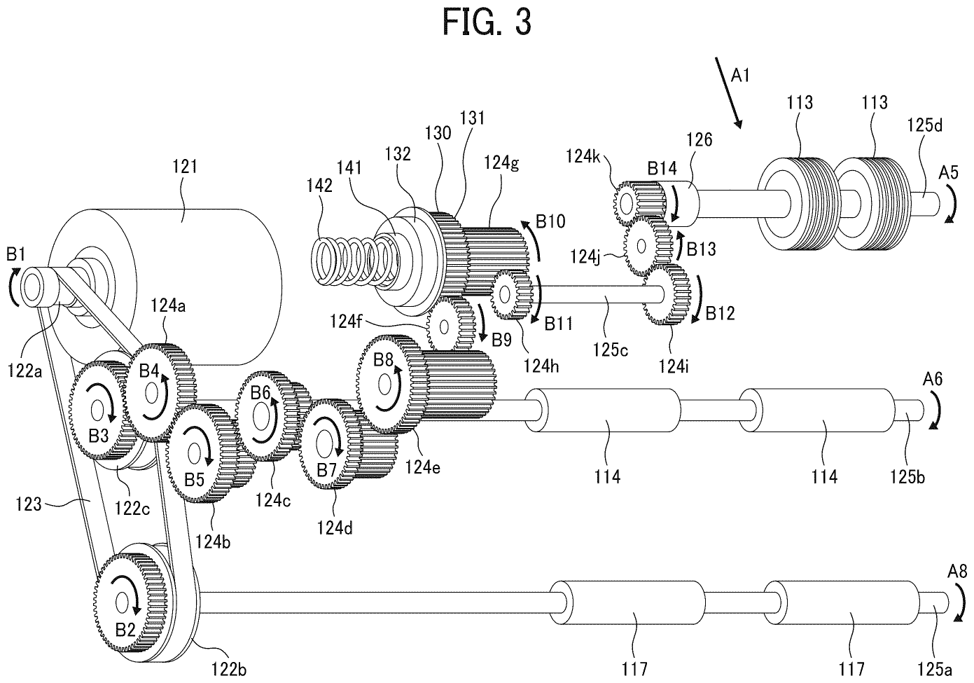

FIG. 3 is a schematic perspective view of a driving mechanism for the separation roller, the conveyance roller, and the ejection roller. FIG. 3 is a perspective view of the driving mechanism for the rollers as viewed from above.

As illustrated in FIG. 3, the driving mechanism for the separation roller 113, the first conveyance roller 114, and the first ejection roller 117 includes a first motor 121, first to third pulleys 122a to 122c, a belt 123, first to eleventh gears 124a to 124k, first to fourth shafts 125a to 125d, a torque limiter 126, and a clutch 130.

The first motor 121 is an example of a driving source, and generates a driving force for rotating the separation roller 113, the first conveyance roller 114, and the first ejection roller 117 according to a control signal from a processing circuit described later. The first motor 121 is, for example, a direct current (DC) motor. The first motor 121 is not limited to a DC motor but may be another motor such as a stepper motor. The first motor 121 generates a driving force for rotating the separation roller 113 in the direction A5 opposite to the medium feeding direction and rotating the first conveyance roller 114, the second conveyance roller 115, the first ejection roller 117, and the second ejection roller 118 in the directions indicated by arrows A6 to A9, respectively, for conveying a medium. The directions A6 to A9 may be referred to as the medium conveying directions A6 to A9 in the following description. The second conveyance roller 115 and the second ejection roller 118 may be driven rollers to be rotated by the first conveyance roller 114 and the first ejection roller 117, respectively. Further, the first conveyance roller 114, the second conveyance roller 115, the first ejection roller 117, and/or the second ejection roller 118 may be rotated by a driving force generated by a motor different from the first motor 121.

The first pulley 122a is mounted on the rotation shaft of the first motor 121, and the belt 123 is stretched around the first pulley 122a, the second pulley 122b, and the third pulley 122c. The second pulley 122b is mounted on the first shaft 125a, and the first ejection roller 117 is mounted on the first shaft 125a. The third pulley 122c is mounted on the second shaft 125b, and the first conveyance roller 114 is mounted on the second shaft 125b.

The third pulley 122c includes a gear portion engaged with the first gear 124a. The first gear 124a is engaged with the second gear 124b. The second gear 124b is engaged with the third gear 124c. The third gear 124c is engaged with the fourth gear 124d. The fourth gear 124d is engaged with the fifth gear 124e. The fifth gear 124e is engaged with the sixth gear 124f.

The clutch 130 is a mechanical clutch and includes a driving wheel 131 and a driven wheel 132. The driving wheel 131 includes a gear on the outer periphery thereof, and the sixth gear 124f is engaged with the driving wheel 131. The coupling and uncoupling between the driven wheel 132 and the driving wheel 131 is switchable. The driven wheel 132 rotates in conjunction with the seventh gear 124g.

The seventh gear 124g is engaged with the eighth gear 124h. The eighth gear 124h is mounted on the third shaft 125c, and the ninth gear 124i is mounted on the third shaft 125c. The ninth gear 124i is engaged with the tenth gear 124j. The tenth gear 124j is engaged with the eleventh gear 124k. The eleventh gear 124k is mounted on the fourth shaft 125d, and the separation roller 113 is mounted on the fourth shaft 125d.

The torque limiter 126 is located on the fourth shaft 125d. The torque limiter 126 determines the limit of the torque applied to the separation roller 113. The limit of the torque limiter 126 is set to satisfy the following conditions. The rotational force via the torque limiter 126 is cut off when there is one medium, and the rotational force via the torque limiter 126 is transmitted when there are two or more media. As a result, when only one medium is conveyed, the separation roller 113 is rotated by the feed roller 112 without receiving the driving force from the first motor 121. When two or more media are conveyed, the separation roller 113 rotates in the direction A5 opposite to the medium feeding direction and separates the medium in contact with the feed roller 112 from other media, to prevent the occurrence of multi-feed. At this time, instead of rotating in the direction A5 opposite to the medium feeding direction, the separation roller 113 may be kept stationary such that the outer circumferential surface of the separation roller 113 applies force to the media in the direction A5 opposite to the medium feeding direction.

The operations of the rollers and the driving mechanism for the rollers are described below.

In the following description, among the driving forces generated by the first motor 121, the driving force in the rotational direction indicated by arrow B1 in FIG. 3 may be referred to as a first driving force, and the driving force in the rotational direction opposite to the direction B1 in FIG. 3 may be referred to as a second driving force. When the first motor 121 generates the first driving force, the first pulley 122a rotates in the direction B1, and the second pulley 122b and the third pulley 122c rotate in the directions indicated by arrows B2 and B3, respectively, following the first pulley 122a. Thus, the first ejection roller 117 is rotated by the first driving force from the first motor 121 and conveys the medium in the medium conveying direction A8 together with the first shaft 125a being the rotation shaft thereof. The first conveyance roller 114 is rotated by the first driving force from the first motor 121 in the medium conveying direction A6 together with the second shaft 125b being the rotation shaft thereof.

The driving mechanism further includes a gear, a pulley, a belt, or the like between the gear portion of the third pulley 122c and the rotation shaft of the second conveyance roller 115 and/or between the gear portion of the second pulley 122b and the rotation shaft of the second ejection roller 118. The second conveyance roller 115 is rotated in the medium conveying direction A7 by the first driving force from the first motor 121. The second ejection roller 118 is rotated in the medium conveying direction A9 by the first driving force from the first motor 121 and conveys the medium.

The first to sixth gears 124a to 124f rotate in the directions indicated by arrows B4 to B9, respectively, and the driving wheel 131 of the clutch 130 rotates in the direction indicated by arrow B10. In this way, the driving wheel 131 is rotated by the first driving force from the first motor 121. When the driven wheel 132 is coupled to the driving wheel 131, the seventh gear 124g rotates in the direction B10 in conjunction with the driven wheel 132. The eighth to eleventh gears 124h to 124k rotate in the directions indicated by arrows B11 to B14, respectively. As a result, the separation roller 113 is rotated by the first driving force from the first motor 121 in the direction A5, which is opposite to the medium feeding direction, together with the fourth shaft 125d being the rotation shaft thereof, and separates the medium. Thus, when coupled to the driving wheel 131, the driven wheel 132 transmits the driving force from the driving wheel 131 to the separation roller 113. By contrast, when the driven wheel 132 is not coupled to the driving wheel 131, the driving force from the first motor 121 is not transmitted to the seventh to eleventh gears 124g to 124k and is not transmitted to the separation roller 113.

When the first motor 121 generates the second driving force, the first conveyance roller 114, the second conveyance roller 115, the first ejection roller 117, and the second ejection roller 118 rotate in the directions opposite to the medium conveying directions A6 to A9, respectively. When the first motor 121 generates the second driving force, the driving wheel 131 rotates in the direction opposite to the direction B10. At this time, when the driven wheel 132 is coupled to the driving wheel 131, the separation roller 113 rotates in the medium feeding direction (the direction opposite to the direction A5 in FIG. 3) to feed the medium. By contrast, when the driven wheel 132 is not coupled to the driving wheel 131, the driving force from the first motor 121 is not transmitted to the separation roller 113.

FIGS. 4A-1 to 4D-2 and FIGS. 5A-1 to 5D-2 are schematic diagrams for explaining the operation of the clutch 130. Among FIGS. 4A-1 to 4D-2 and FIGS. 5A-1 to 5D-2, the diagrams on the right illustrate the inside of the driving wheel as viewed from the side opposite to the driven wheel, and the diagrams on the left illustrate the inside of the driven wheel as viewed from the side opposite to the driving wheel.

As illustrated in FIGS. 4A-1 to 4D-2 and FIGS. 5A-1 to 5D-2, the clutch 130 includes an operating wheel 133 in addition to the driving wheel 131 and the driven wheel 132. The operating wheel 133 is located inside the clutch 130.

Inside the driving wheel 131, a groove 131a is formed. The groove 131a includes an arc-shaped first groove portion 131b, a second groove portion 131c, and a third groove portion 131d. The second groove portion 131c and the third groove portion 131d extend from a central portion of the first groove portion 131b toward the center of the driving wheel 131. The driving wheel 131 further includes a swingable claw 131e therein. The swing shaft of the claw 131e is located closer to the center of the driving wheel 131 than the first groove portion 131b. The swing end of the claw 131e includes a projection projecting toward the groove 131a such that the claw 131e moves in the groove 131a. The claw 131e is swingable from the position at which the claw 131e closes the entrance of the second groove portion 131c to the position at which the claw 131e does not close the entrance of the third groove portion 131d.

The driven wheel 132 has multiple recesses 132a formed therein. Each recess 132a is formed in the center portion of the driven wheel 132 (closer to the center than the position facing the first groove portion 131b) and opens from the center of the driven wheel 132 toward the circumference.

The operating wheel 133 includes an arm 133a. The arm 133a is swingable about a swing shaft 133b. At the swing end of the arm 133a, an arm pin 133c is located. The arm pin 133c protrudes toward the driving wheel 131 to move in the groove 131a, and protrudes toward the driven wheel 132 to enter the recess 132a. The arm 133a is applied with a pressing force by a pressing part, such as a torsion coil spring, such that the arm pin 133c is directed toward the centers of the driving wheel 131 and the driven wheel 132.

In the state illustrated in FIGS. 4A-1 and 4A-2, in the driving wheel 131, the arm pin 133c is positioned at the end of the first groove portion 131b closer to the second groove portion 131c, and the claw 131e closes the entrance of the second groove portion 131c. At this time, the arm pin 133c is located outside the recess 132a of the driven wheel 132, and the driving wheel 131 and the driven wheel 132 are not coupled to each other.

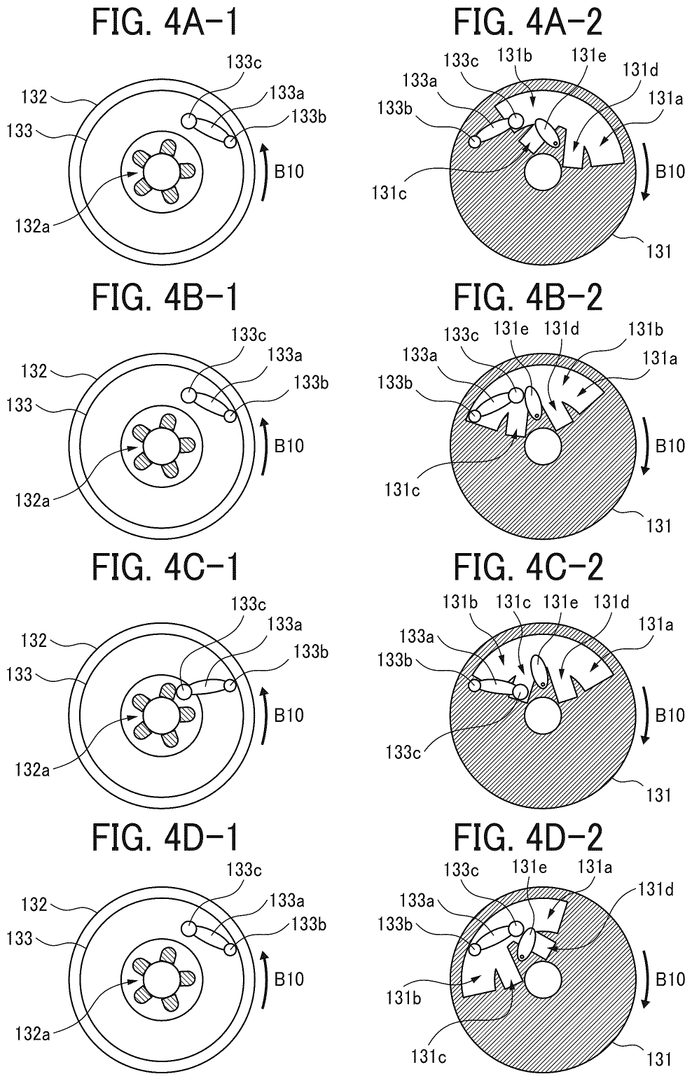

When the driving wheel 131 rotates a predetermined amount in the direction opposite to the direction B10 from the position illustrated in FIG. 4A-2, the groove 131a rotates in the direction opposite to the direction B10, and the arm pin 133c is positioned near the entrance of the second groove portion 131c as illustrated in FIG. 4B-2. At this time, the swing end of the claw 131e is moved toward the third groove portion 131d by the arm pin 133c and opens the entrance of the second groove portion 131c.

When the driving wheel 131 rotates in the direction B10 from the position illustrated in FIG. 4B-2, the arm pin 133c enters the second groove portion 131c as illustrated in FIG. 4C-2 because the arm pin 133c is pressed toward the center of the driving wheel 131 by the pressing part. In the driven wheel 132, the arm pin 133c engages with the recess 132a. After that, when the first motor 121 generates the first driving force and the driving wheel 131 rotates in the direction B10, the rotational force of the driving wheel 131 is transmitted to the driven wheel 132 via the arm 133a, and the driven wheel 132 rotates in conjunction with the driving wheel 131. In this way, the driven wheel 132 is coupled to the driving wheel 131 to transmit the first driving force from the first motor 121 to the separation roller 113.

When the driving wheel 131 rotates in the direction opposite to the direction B10 from the position illustrated in FIG. 4C-2, the groove 131a rotates in the direction opposite to the direction B10, and the arm pin 133c moves from the second groove portion 131c to the first groove portion 131b as illustrated in FIG. 4D-2. As a result, the arm pin 133c is located outside the recess 132a in the driven wheel 132, and the driven wheel 132 is uncoupled from the driving wheel 131. After that, the arm pin 133c contacts the claw 131e, and the claw 131e swings toward the third groove portion 131d and is positioned to close the entrance of the third groove portion 131d. Although the arm pin 133c is pressed toward the center of the driving wheel 131 by the pressing part, the claw 131e prevents the arm pin 133c from entering the third groove portion 131d.

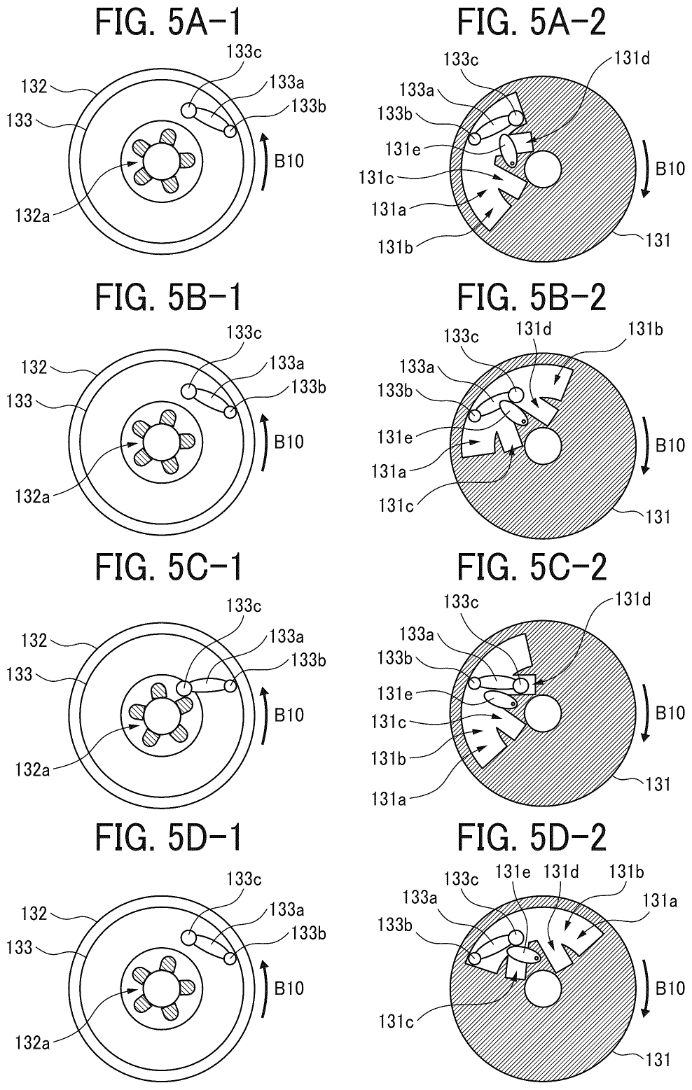

When the driving wheel 131 further rotates in the direction opposite to the direction B10 from the position illustrated in FIG. 4D-2, the groove 131a rotates in the direction opposite to the direction B10, and the arm pin 133c reaches the end of the first groove portion 131b closer to the third groove portion 131d in the driving wheel 131, as illustrated in FIG. 5A-2.

When the driving wheel 131 rotates a predetermined amount in the direction B10 from the position illustrated in FIG. 5A-2, the groove 131a rotates in the direction B10, and the arm pin 133c is located near the entrance of the third groove portion 131d as illustrated in FIG. 5B-2. At this time, the swing end of the claw 131e is moved toward the second groove portion 131c by the arm pin 133c and opens the entrance of the third groove portion 131d.

When the driving wheel 131 rotates in the direction opposite to the direction B10 from the position illustrated in FIG. 5B-2, the arm pin 133c enters the third groove portion 131d as illustrated in FIG. 5C-2 because the arm pin 133c is pressed toward the center of the driving wheel 131 by the pressing part. In the driven wheel 132, the arm pin 133c engages with the recess 132a. After that, when the first motor 121 generates the second driving force and the driving wheel 131 rotates in the direction opposite to the direction B10, the rotational force of the driving wheel 131 is transmitted to the driven wheel 132 via the arm 133a, and the driven wheel 132 rotates in conjunction with the driving wheel 131. In this way, the driven wheel 132 is coupled to the driving wheel 131 to transmit the second driving force from the first motor 121 to the separation roller 113.

When the driving wheel 131 rotates in the direction B10 from the position illustrated in FIG. 5C-2, the groove 131a rotates in the direction B10, and the arm pin 133c moves from the third groove portion 131d to the first groove portion 131b as illustrated in FIG. 5D-2. As a result, the arm pin 133c is located outside the recess 132a in the driven wheel 132, and the driven wheel 132 is uncoupled from the driving wheel 131. After that, the arm pin 133c contacts the claw 131e, and the claw 131e swings toward the second groove portion 131c and is positioned to close the entrance of the second groove portion 131c. Although the arm pin 133c is pressed toward the center of the driving wheel 131 by the pressing part, the claw 131e prevents the arm pin 133c from entering the second groove portion 131c.

When the driving wheel 131 further rotates in the direction B10 from the position illustrated in FIG. 5D-2, the groove 131a rotates in the direction B10, and the arm pin 133c reaches the end of the first groove portion 131b closer to the second groove portion 131c in the driving wheel 131, as illustrated in FIG. 4A-2.

When the driving wheel 131 continues to rotate in the direction opposite to the direction B10 from the position illustrated in FIG. 4A-2, the claw 131e prevents the arm pin 133c from entering the third groove portion 131d, and the arm pin 133c reaches the end of the first groove portion 131b closer to the third groove portion 131d. Similarly, when the driving wheel 131 continues to rotate in the direction B10 from the position illustrated in FIG. 5A-2, the claw 131e prevents the arm pin 133c from entering the second groove portion 131c, and the arm pin 133c reaches the end of the first groove portion 131b closer to the second groove portion 131c. Therefore, when the driving wheel 131 continues to rotate in one direction in the state illustrated in FIGS. 4A-1 and 4A-2 or FIGS. 5B-1 and 5B-2, the driven wheel 132 is not coupled to the driving wheel 131, and the clutch 130 does not transmit the first driving force and the second driving force from the first motor 121 to the separation roller 113.

In this way, the coupling and uncoupling of the driven wheel 132 to and from the driving wheel 131 is switched by the rotation of the driving wheel 131.

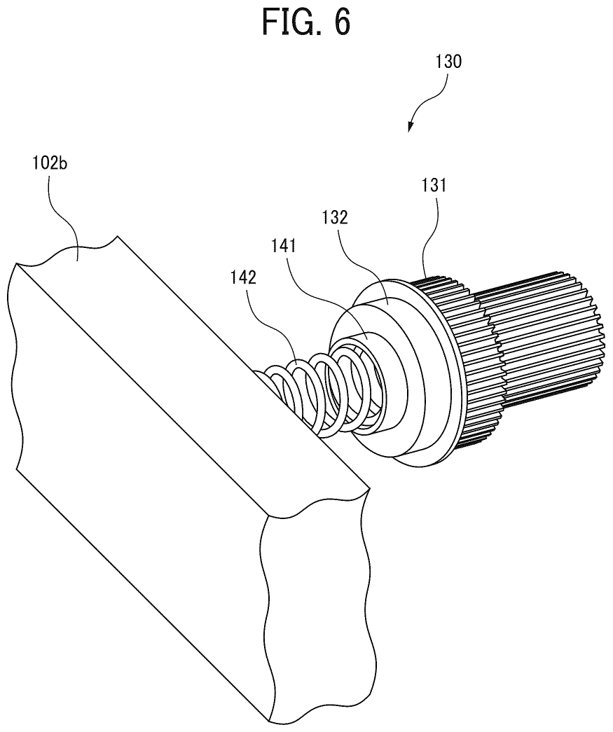

FIG. 6 is a schematic view of the clutch 130 for explaining an applying part 141 and a pressing part 142.

As illustrated in FIG. 6, the medium conveying apparatus 100 further includes the applying part 141 and the pressing part 142.

The applying part 141 is made of, for example, rubber, resin, or metal, and is in contact with the driven wheel 132. The applying part 141 applies a frictional force to the driven wheel 132 to restrict the rotation of the driven wheel 132 rotated by the driving wheel 131. As described above, the coupling and uncoupling of the driven wheel 132 to and from the driving wheel 131 is switched by the rotation of the driving wheel 131. By contrast, when the driving wheel 131 is rotated to switch between the coupling and uncoupling of the driven wheel 132 to and from the driving wheel 131, the coupling and uncoupling is not properly switched if the driven wheel 132 is rotated by the driving wheel 131. The medium conveying apparatus 100 can appropriately switch between coupling and uncoupling of the driven wheel 132 to and from the driving wheel 131 by applying, to the driven wheel 132, the frictional force for restricting the rotation of the driven wheel 132 rotated by the driving wheel 131.

The frictional force applied by the applying part 141 is set in advance to be greater than the frictional force between the driving wheel 131 and the driven wheel 132. Thus, the medium conveying apparatus 100 can prevent the driven wheel 132 from being rotated by the driving wheel 131, and can appropriately switch between coupling and decoupling with the driving wheel 131.

Further, the magnitude of the frictional force applied by the applying part 141 to the separation roller 113 operating in the non-separation mode is preferably set not to apply a load for separating the medium. In other words, the frictional force applied by the applying part 141 is preferably set to be smaller than the back load for the separation roller 113 to separate the medium. This enables the separation roller 113 to be rotated by the feed roller 112 to feed the medium, without separating the medium, when the separation roller 113 operates in the non-separation mode.

The applying part 141 is located in contact with the side face of the driven wheel 132 intersecting the rotation axis. In particular, the side face is on the opposite side to the driving wheel 131. Thus, the applying part 141 can efficiently apply the frictional force to the driven wheel 132 and properly restrict the rotation of the driven wheel 132.

For example, the pressing part 142 is a spring such as a compression coil spring. The pressing part 142 may be another elastic member such as another spring (e.g., a flat spring) or a rubber member. One end of the pressing part 142 is attached to a frame 102b fixed to the upper housing 102, and the other end of the pressing part 142 is attached to the face of the applying part 141 on the side opposite to the driven wheel 132. The pressing part 142 presses the applying part 141 toward the driven wheel 132. As a result, the medium conveying apparatus 100 can properly apply, to the driven wheel 132, the frictional force for restricting the rotation of the driven wheel 132 rotated by the driving wheel 131 and switch between coupling and uncoupling of the driven wheel 132 to and from the driving wheel 131. Instead of the pressing part 142, for example, a fixing portion to secure the applying part 141 at the position in contact with the driven wheel 132 may be used.

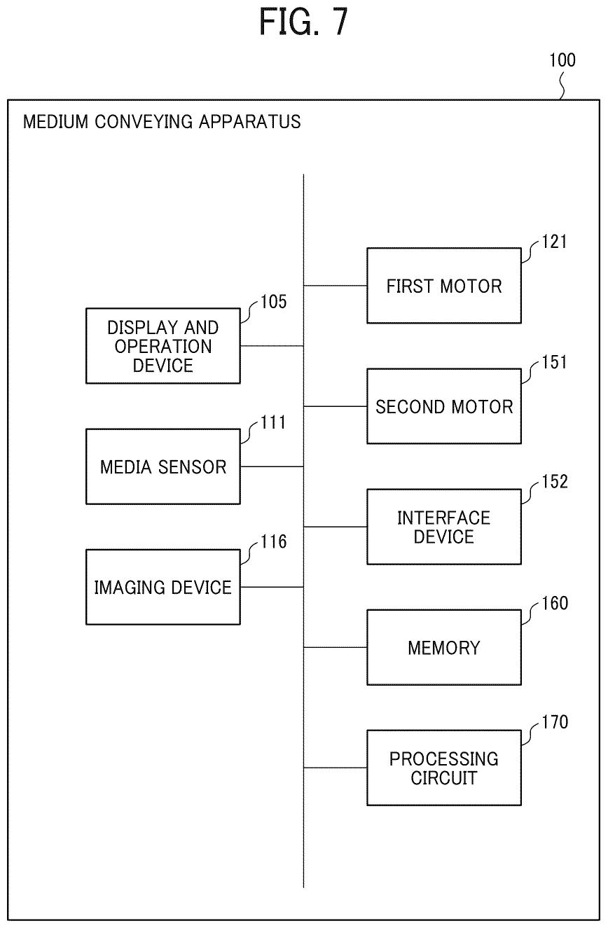

FIG. 7 is a block diagram illustrating a schematic configuration of the medium conveying apparatus 100.

The medium conveying apparatus 100 further includes a second motor 151, an interface device 152, a memory 160, and a processing circuit 170 in addition to the above-described components.

The second motor 151 generates a driving force for rotating the feed roller 112 to feed a medium according to a control signal from a processing circuit 170. The second motor 151 is, for example, a DC motor. The second motor 151 is not limited to a DC motor but may be another motor such as a stepper motor. The second motor 151 generates a driving force for rotating the feed roller 112 in the medium feeding direction A4 (see FIG. 1). The feed roller 112 may be driven by the driving force from the first motor 121. The first conveyance roller 114, the second conveyance roller 115, the first ejection roller 117, and/or the second ejection roller 118 may be driven by the driving force from the second motor 151.

The interface device 152 includes an interface circuit compatible with a serial bus such as a universal serial bus (USB) and is electrically connected to an information processing apparatus (e.g., a personal computer or a mobile information processing terminal) to transmit and receive input images and various kinds of information to and from the information processing apparatus. The interface device 152 may be substituted by a communication device that includes an antenna to transmit and receive wireless signals and a wireless communication interface device to transmit and receive signals through a wireless communication line according to a predetermined communication protocol. The predetermined communication protocol is, for example, a wireless local area network (LAN) communication protocol. The communication device may include a wired communication interface device to transmit and receive signals through a wired communication line according to a communication protocol such as a wired LAN communication protocol.

The memory 160 includes memories such as a random-access memory (RAM) and a read-only memory (ROM), a fixed disk device such as a hard disk, or a portable memory such as a flexible disk or an optical disk. The memory 160 stores, for example, computer programs, databases, and tables used for various processes performed by the medium conveying apparatus 100. The computer programs may be installed in the memory 160 from a computer-readable portable recording medium using, for example, a setup program. Examples of the portable recording medium include a compact disc read-only memory (CD-ROM) and a digital versatile disc read-only memory (DVD-ROM). The computer programs may be distributed from, for example, a server and installed in the memory 160.

The processing circuit 170 operates according to a program prestored in the memory 160. The processing circuit is, for example, a central processing unit (CPU). Alternatively, a digital signal processor (DSP), a large-scale integration (LSI), an application-specific integrated circuit (ASIC), a field-programmable gate array (FPGA), etc., may be used as the processing circuit 170.

The processing circuit 170 is connected to the display and operation device 105, the media sensor 111, the imaging device 116, the first motor 121, the second motor 151, the interface device 152, the memory 160, etc., and controls these devices. The processing circuit 170 controls the driving of the first motor 121, the second motor 151, the imaging by the imaging device 116, etc., according to the media signals received from the media sensor 111. The processing circuit 170 obtains an input image from the imaging device 116 and transmits the input image to the information processing apparatus via the interface device 152.

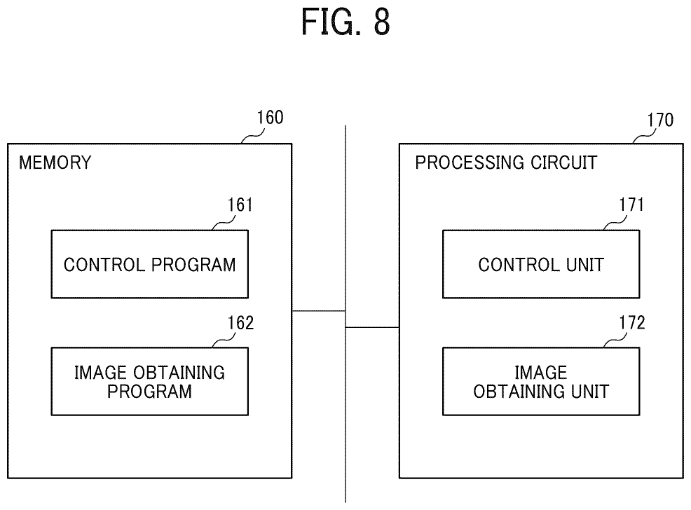

FIG. 8 is a block diagram illustrating a schematic configuration of the memory 160 and the processing circuit 170.

As illustrated in FIG. 8, the memory 160 stores a control program 161 and an image obtaining program 162. These programs are functional modules implemented by software that operates on the processor. The processing circuit 170 reads the programs from the memory 160 and operates according to the read programs. Thus, the processing circuit 170 functions as a control unit 171 and an image obtaining unit 172.

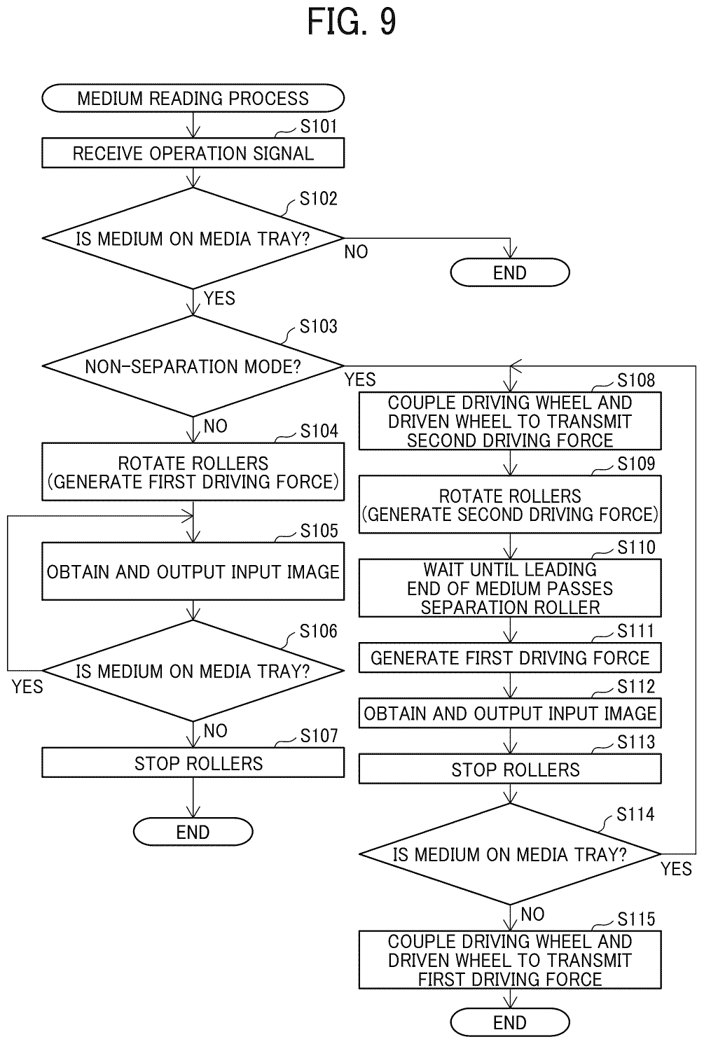

FIG. 9 is a flowchart of a medium conveying process performed by the medium conveying apparatus 100.

The medium conveying process performed by the medium conveying apparatus 100 is described below with reference to the flowchart of FIG. 9. The process described below is executed, for example, by the processing circuit 170 in cooperation with the components of the medium conveying apparatus 100 based on the program prestored in the memory 160.

The control unit 171 controls the clutch 130 to couple the driving wheel 131 with the driven wheel 132 at the start-up of the medium conveying apparatus 100 (e.g., at the power-on or when the media tray 103 is opened). In particular, the control unit 171 couples the driving wheel 131 with the driven wheel 132 to transmit the first driving force from the first motor 121 to the separation roller 113 at the start-up of the medium conveying apparatus 100. The control unit 171 drives the first motor 121 to rotate the driving wheel 131 in the direction B10 (see FIGS. 4A-1 to 5D-2) by a first predetermined amount, rotate the driving wheel 131 in the direction opposite to the direction B10 by a second predetermined amount, and further rotate the driving wheel 131 in the direction B10 by a third predetermined amount. The first predetermined amount, the second predetermined amount, and the third predetermined amount are predetermined according to the specifications of the clutch 130. After that, when the first motor 121 is driven to rotate the driving wheel 131 in the direction B10 (to generate the first driving force), the first driving force from the first motor 121 is transmitted to the first conveyance roller 114, the second conveyance roller 115, the first ejection roller 117, and the second ejection roller 118, and is further transmitted to the separation roller 113.

The separation roller 113 operates in either the separation mode or the non-separation mode. In the separation mode, the separation roller 113 separates the medium by the first driving force from the first motor 121. By contrast, in the non-separation mode, the separation roller 113 feeds the medium with the second driving force from the first motor 121, after which the driving force from the first motor 121 is cut off, and the separation roller 113 is rotated by the feed roller 112. Typically, the medium conveying apparatus 100 is set to operate in the non-separation mode when a special medium such as a card, a booklet, or a passport is conveyed, and to operate in the separation mode when a standard medium (e.g., plain paper sheet) is conveyed. Accordingly, for the medium conveying apparatus 100, the frequency of operating in the non-separation mode is typically lower than the frequency of operating in the separation mode. The medium conveying apparatus 100 can reduce the necessity to switch the clutch 130 in the medium conveying process and reduce the processing time for the medium conveying process by coupling the driving wheel 131 and the driven wheel 132 at the time of the start-up of the apparatus.

In step S101, the control unit 171 stands by until an operation signal instructing the reading of a medium is received from the display and operation device 105 or an information processing apparatus via the interface device 152. The operation signal is output when a user inputs an instruction to read the medium using the display and operation device 105 or the information processing apparatus. The operation signal includes the operation mode (separation mode/non-separation mode) of the medium conveying apparatus 100 designated in addition to the reading instruction instructed by the user using the display and operation device 105 or an information processing apparatus. The operation mode may not be included in the operation signal and may be set before the medium reading process is executed.

In step S102, the control unit 171 obtains a media signal from the media sensor 111 and determines whether a medium is placed on the media tray 103 based on the obtained media signal. The control unit 171 ends the series of steps when no medium is placed on the media tray 103.

By contrast, when a medium is on the media tray 103 (Yes in step S102), the control unit 171 determines whether the non-separation mode is designated for the medium conveying apparatus 100 in step S103.

When the operation mode is the separation mode (No in step S102), the control unit 171 does not switch the clutch 130 since the driving wheel 131 is already coupled to the driven wheel 132 to transmit the first driving force from the first motor 121 to the separation roller 113. In step S104, the control unit 171 controls the first motor 121 and the second motor 151 to rotate the rollers to convey the medium. The control unit 171 controls the second motor 151 to generate a driving force for rotating the feed roller 112 in the medium feeding direction A4. Further, the control unit 171 controls the first motor 121 to generate the first driving force for rotating the separation roller 113 in the direction A5 opposite to the medium feeding direction, and to rotate the first conveyance roller 114, the second conveyance roller 115, the first ejection roller 117, and the second ejection roller 118 in the medium conveying directions A6 to A9, respectively.

In step S105, the image obtaining unit 172 controls the imaging device 116 to image the medium, obtains an input image from the imaging device 116, and transmits the obtained input image to the information processing apparatus via the interface device 152 to output the input image.

In step S106, the control unit 171 determines whether a medium remains on the media tray 103 based on the media signal received from the media sensor 111. When a medium remains on the media tray 103, the control unit 171 returns the process to step S105 and repeats the operations of steps S105 and S106.

By contrast, when no medium remains on the media tray 103 (No in step S106), the control unit 171 controls the first motor 121 and the second motor 151 to stop the feed roller 112, the separation roller 113, the first conveyance roller 114, the second conveyance roller 115, the first ejection roller 117, and/or the second ejection roller 118 in step S107. At this time, since the driving wheel 131 is coupled to the driven wheel 132 to transmit the first driving force from the first motor 121 to the separation roller 113, the control unit 171 does not switch the clutch 130 and ends the process.

By contrast, when the operation mode is the non-separation mode (Yes in step S103), the control unit 171 couples the driving wheel 131 to the driven wheel 132 to transmit the second driving force from the first motor 121 to the separation roller 113 in step S108. The control unit 171 drives the first motor 121 to rotate the driving wheel 131 in the direction opposite to the direction B10 (see FIGS. 4A-1 to 5D-2) by a fourth predetermined amount, rotate the driving wheel 131 in the direction B10 by a fifth predetermined amount, and further rotate the driving wheel 131 in the direction opposite to the direction B10 by a sixth predetermined amount. The fourth predetermined amount, the fifth predetermined amount, and the sixth predetermined amount are predetermined according to the specifications of the clutch 130. After that, when the first motor 121 is driven to rotate the driving wheel 131 in the direction opposite to the direction B10 (to generate the second driving force), the second driving force from the first motor 121 is transmitted to the first conveyance roller 114, the second conveyance roller 115, the first ejection roller 117, and the second ejection roller 118, and is further transmitted to the separation roller 113.

In step S109, the control unit 171 controls the first motor 121 and the second motor 151 to rotate the rollers to convey the medium. The control unit 171 controls the second motor 151 to generate a driving force for rotating the feed roller 112 in the medium feeding direction A4. Further, the control unit 171 controls the first motor 121 to generate the second driving force for rotating the separation roller 113 in the medium feeding direction. At this time, the first conveyance roller 114, the second conveyance roller 115, the first ejection roller 117, and the second ejection roller 118 rotate in the directions opposite to the medium conveying directions A6 to A9, respectively. However, no problem occurs because the leading end of the medium does not reach the positions of the first conveyance roller 114, the second conveyance roller 115, the first ejection roller 117, and the second ejection roller 118 at that time.

In step S110, the control unit 171 waits until the leading end of the medium passes through the nip between the feed roller 112 and the separation roller 113. The control unit 171 determines that the leading end of the medium passes the nip between the feed roller 112 and the separation roller 113, for example, when a predetermined time elapses after the feeding of the medium is started. The predetermined time is set to the time from when the leading end of the medium passes the upstream end of the nip between the feed roller 112 and the separation roller 113 to when the trailing end of the medium reaches the downstream end of the nip plus a margin.

The medium conveying apparatus 100 may further include a second media sensor located between the feed roller 112 and the first conveyance roller 114 in the medium conveying direction A1, particularly near the feed roller 112. The second media sensor includes, for example, a light emitter and a light receiver located on one side of the medium conveying path, and a light guide facing the light emitter and the light receiver across the medium conveying path. The light guide is, for example, a U-shaped prism. The light emitter is, for example, a light-emitting diode (LED) and emits light toward the medium conveying path. The light receiver is, for example, a photodiode and receives light emitted from the light emitter and guided by the light guide. The light receiver generates and outputs a second media signal based on the intensity of the light received. The value of the second media signal changes depending on whether a medium is present at the position of the second media sensor. Further, the second media sensor may be a contact sensor that allows a predetermined amount of electrical current to flow when a medium is in contact or not in contact therewith. The control unit 171 determines that the leading end of the medium passes the nip between the feed roller 112 and the separation roller 113 when the signal value of the second media signal output from the second media sensor changes from the value indicating the absence of a medium to the value indicating the presence of a medium.

In step S111, the control unit 171 controls the first motor 121 to generate the first driving force for uncoupling the driven wheel 132 from the driving wheel 131. After that, when the first motor 121 is driven to rotate the driving wheel 131 in the direction B10 (to generate the first driving force), the first driving force from the first motor 121 is transmitted to the first conveyance roller 114, the second conveyance roller 115, the first ejection roller 117, and the second ejection roller 118 but is not transmitted to the separation roller 113. Accordingly, the separation roller 113 is rotated by the feed roller 112, and the first conveyance roller 114, the second conveyance roller 115, the first ejection roller 117, and the second ejection roller 118 convey the medium with the first driving force.

As described above, in the non-separation mode, a special medium such as a card, a booklet, or a passport, particularly, a thick medium is likely conveyed. The medium conveying apparatus 100 can obtain the force for stably feeding the medium by rotating the separation roller 113 by the second driving force from the first motor 121 at the start of feeding the medium. By contrast, the medium conveying apparatus 100 can reduce the load on the medium to reduce damage to the medium by controlling the separation roller 113 to be rotated by the feed roller 112 after the medium passes the separation roller 113.

In step S112, the image obtaining unit 172 obtains an input image from the imaging device 116 and transmits the obtained input image to the information processing apparatus via the interface device 152 to output the input image, similarly to step S105.

In step S113, the control unit 171 controls the first motor 121 and the second motor 151 to stop the feed roller 112, the separation roller 113, the first conveyance roller 114, the second conveyance roller 115, the first ejection roller 117, and/or the second ejection roller 118.

In step S114, the control unit 171 determines whether a medium remains on the media tray 103 based on the media signal received from the media sensor 111. When a medium remains on the media tray 103, the control unit 171 returns the process to step S108 and repeats the operations of steps S108 to S114.

By contrast, when no media remain on the media tray 103 (No in step S114), the control unit 171 sets the clutch 130 to couple the driving wheel 131 to the driven wheel 132 in step S115, which is similar to the operation at the start-up of the medium conveying apparatus 100. Then, the series of steps is ended. In particular, the control unit 171 couples the driving wheel 131 to the driven wheel 132 to transmit the first driving force from the first motor 121 to the separation roller 113. After that, when the first motor 121 is driven to rotate the driving wheel 131 in the direction B10 (to generate the first driving force), the first driving force from the first motor 121 is transmitted to the first conveyance roller 114, the second conveyance roller 115, the first ejection roller 117, and the second ejection roller 118, and is further transmitted to the separation roller 113.

In this way, the control unit 171 sets the clutch 130 to couple the driving wheel 131 to the driven wheel 132 after conveying the medium completes. Accordingly, the medium conveying apparatus 100 can reduce the necessity to switch the clutch 130 in the next medium conveying process, thereby reducing the processing time of the medium conveying process.

In step S108, the control unit 171 may uncouple the driving wheel 131 from the driven wheel 132 instead of coupling the driving wheel 131 to the driven wheel 132 to transmit the second driving force from the first motor 121 to the separation roller 113. In this case, the control unit 171 drives the first motor 121 to rotate the driving wheel 131 in the direction opposite to the direction B10 by a seventh predetermined amount (see FIGS. 4A-1 to 5D-2). The seventh predetermined amount is predetermined according to the specifications of the clutch 130. In this case, in step S109, the control unit 171 controls the first motor 121 to generate the first driving force and rotates the first conveyance roller 114, the second conveyance roller 115, the first ejection roller 117, and the second ejection roller 118 in the medium conveying directions A6 to A9, respectively. The first driving force is not transmitted to the separation roller 113, and the separation roller 113 is rotated by the feed roller 112.

Further, the control unit 171 may couple the driving wheel 131 to the driven wheel 132 to transmit the second driving force from the first motor 121 to the separation roller 113 at the start-up of the apparatus and/or after conveying the medium completes. In this case, when determining that the operation mode is the non-separation mode in step S103, the control unit 171 does not perform any particular operation. When determining that the operation mode is the separation mode in step S103, the control unit 171 couples the driving wheel 131 to the driven wheel 132 to transmit the first driving force from the first motor 121 to the separation roller 113. The control unit 171 may uncouple the driving wheel 131 from the driven wheel 132 at the start-up of the apparatus and/or after conveying the medium completes. Alternatively, the control unit 171 may not set the clutch 130 at the start-up of the apparatus and/or after conveying the medium completes. In such a case, when determining that the operation mode is the non-separation mode in step S103, the control unit 171 couples the driving wheel 131 to the driven wheel 132 to transmit the second driving force from the first motor 121 to the separation roller 113. By contrast, when determining that the operation mode is the separation mode in step S103, the control unit 171 couples the driving wheel 131 to the driven wheel 132 to transmit the first driving force from the first motor 121 to the separation roller 113.

As described above in detail, the medium conveying apparatus 100 applies a frictional force to the clutch 130 that is a mechanical clutch, to restrict the rotation of the driven wheel 132 rotated by the driving wheel 131. Thus, the medium conveying apparatus 100 can properly switch between coupling and uncoupling of the driving wheel 131 to and from the driven wheel 132, and can properly switch whether to transmit the driving force from the first motor 121 to the separation roller 113.

In addition, since the medium conveying apparatus 100 uses the clutch 130 that is a mechanical clutch, it is not necessary to apply voltage to the clutch 130 during the medium separation, unlike when an electromagnetic clutch is used. Thus, the power consumption can be reduced.

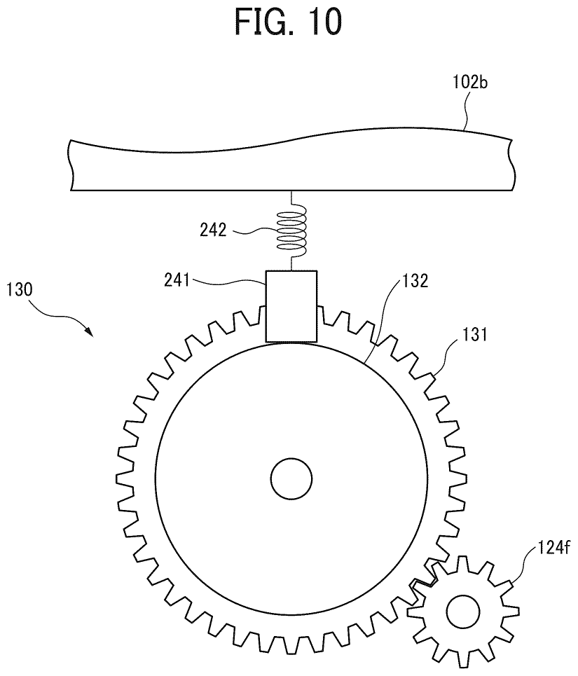

FIG. 10 is a schematic diagram illustrating an applying part 241 of a medium conveying apparatus according to another embodiment.

The medium conveying apparatus according to the present embodiment includes the elements included in the medium conveying apparatus 100. However, the medium conveying apparatus according to the present embodiment includes the applying part 241 and a pressing part 242 instead of the applying part 141 and the pressing part 142 illustrated in FIG. 6. The applying part 241 and the pressing part 242 are similar in configuration and function to the applying part 141 and the pressing part 142, respectively.

However, the applying part 241 is located to contact the outer circumferential surface of the driven wheel 132. This enables the applying part 241 to properly restrict the rotation of the driven wheel 132. In addition, since the applying part 241 is located to contact the outer circumferential surface of the driven wheel 132, the frictional force between the applying part 241 and the driven wheel 132 is easily adjusted, and the design cost of the medium conveying apparatus can be reduced.

The applying part 241 is located to contact the driven wheel 132 from above. Thus, the applying part 241 can efficiently restrict the rotation of the driven wheel 132 by using its own weight.

One end of the pressing part 242 is attached to the frame 102b fixed to the upper housing 102, and the other end of the pressing part 242 is attached to the face of the applying part 241 on the side opposite to the driven wheel 132. The pressing part 242 presses the applying part 241 toward the driven wheel 132. As a result, the medium conveying apparatus can properly apply, to the driven wheel 132, the frictional force for restricting the rotation of the driven wheel 132 rotated by the driving wheel 131 and switch between coupling to and uncoupling from the driving wheel 131. As the pressing part 242, a weight may be used instead of an elastic member such as a spring or a rubber member.

The pressing part 242 may be omitted. Even in that case, the applying part 241 can restrict the rotation of the driven wheel 132 by its own weight. The medium conveying apparatus can properly restrict the rotation of the driven wheel 132 while reducing the cost and the weight of the apparatus.

As described above in detail, the medium conveying apparatus can properly switch whether to transmit the driving force from the first motor 121 to the separation roller 113 when the applying part 241 contacts the outer circumferential surface of the driven wheel 132 and/or contacts the driven wheel 132 from above.

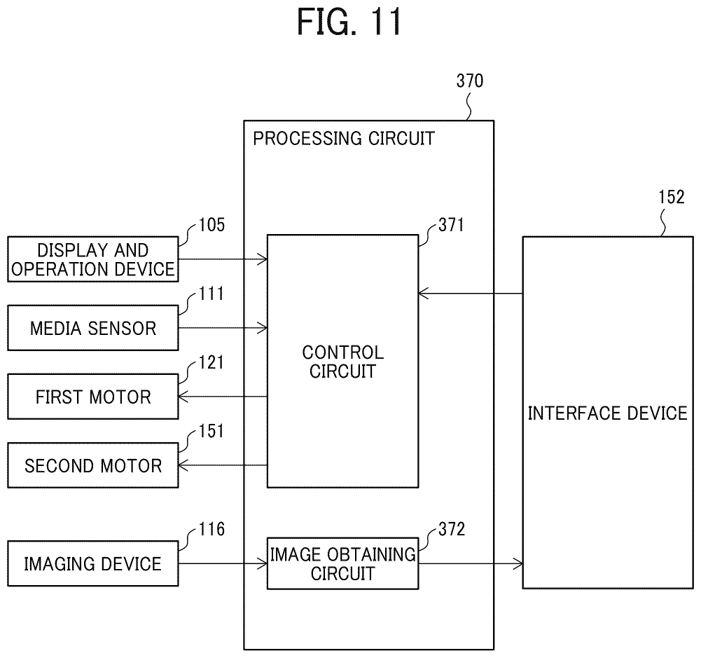

FIG. 11 is a diagram illustrating a schematic configuration of a processing circuit 370 included in another medium conveying apparatus.

The processing circuit 370 is used in place of the processing circuit 170 of the medium conveying apparatus 100 and executes the medium reading process, etc., in place of the processing circuit 170. The processing circuit 370 includes a control circuit 371 and an image obtaining circuit 372. These circuits may be implemented by independent integrated circuits, microprocessors, firmware, or a combination thereof.

The control circuit 371 is an example of control circuitry and functions like the control unit 171. The control circuit 371 receives operation signals from the display and operation device 105 or the interface device 152 and receives the media signal from the media sensor 111. The control circuit 371 controls the first motor 121 and the second motor 151 based on the obtained pieces of information.

The image obtaining circuit 372 functions like the image obtaining unit 172. The image obtaining circuit 372 obtains an input image from the imaging device 116 and outputs the input image to the interface device 152.

As described above in detail, the medium conveying apparatus including the processing circuit 370 can properly switch whether to transmit the driving force from the first motor 121 to the separation roller 113.

Embodiments of the present disclosure are not limited to the above-described embodiments. For example, the medium conveying path may be a so-called U-turn path, and the medium conveying apparatus may feed and convey media placed on the media tray sequentially from the top and eject the media to the ejection tray. In this configuration, the separation roller is located below the feed roller to face the feed roller.

The medium conveying apparatus may include an image forming device instead of or in addition to the imaging device 116. The image forming device employs, for example, an inkjet printing method or a laser printing method, is located at the position corresponding to the position of the imaging device 116, and forms an image (prints predetermined information) on a medium conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A medium conveying apparatus comprising:
a driving source to generate a driving force;
a separation roller to separate a medium with the driving force;
a mechanical clutch including:
a driving wheel rotated by the driving force from the driving source; and
a driven wheel coupled to and uncoupled from the driving wheel by rotation of the driving wheel, wherein the driven wheel coupled to the driving wheel transmits the driving force from the driving wheel to the separation roller; and
an applying part to apply, to the driven wheel, a frictional force for restricting rotation of the driven wheel rotated by the driving wheel,
wherein the frictional force applied by the applying part is greater than a frictional force between the driving wheel and the driven wheel.

2. The medium conveying apparatus according to claim 1, further comprising a feed roller, wherein
the separation roller operates in either a separation mode in which the separation roller separates the medium fed by the feed roller with the driving force, or a non-separation mode in which the separation roller is rotated by the feed roller, and
a magnitude of the frictional force applied by the applying part is set not to apply a load for separating the medium to the separation roller operating in the non-separation mode.

3. The medium conveying apparatus according to claim 1, further comprising:
a feed roller; and
a conveyance roller located downstream from the separation roller in a medium conveying direction, wherein
the conveyance roller conveys the medium by the driving force, and
the separation roller operates in either a separation mode in which the separation roller separates the medium fed by the feed roller with the driving force, or a non-separation mode in which the separation roller is rotated by the feed roller.

4. The medium conveying apparatus according to claim 1, further comprising a pressing part to press the applying part toward the driven wheel.

5. The medium conveying apparatus according to claim 1,
wherein the applying part contacts the driven wheel from above.

6. The medium conveying apparatus according to claim 1,
wherein the applying part contacts a face of the driven wheel intersecting a rotation axis of the driven wheel.

7. The medium conveying apparatus according to claim 1,
wherein the applying part contacts an outer circumferential surface of the driven wheel.

8. The medium conveying apparatus according to claim 1, further comprising control circuitry configured to control the mechanical clutch to couple the driving wheel to the driven wheel at a start-up of the medium conveying apparatus or after conveying the medium completes.
